(19) United States
(12) Patent Application Publication
(10) Pub. No.: US 2006/0252646 A1
(43) Pub. Date: Nov. 9, 2006

(54) Methyl/ethyl ester solutions of pesticides applied to absorbent, particulate substrates and methods of using same

(75) Inventor: Stacy Spence, Winter Haven, FL (US)

Correspondence Address: DENNIS G. LAPOINTE;LAPOINTE LAW GROUP, PL, PO BOX 1294, TARPON SPRINGS, FL, 34688-1294, US

(73) Assignee: ARR-MAZ Products, L.P., Winter Haven, FL (US)

(21) Appl. No.: 11/122,422

(22) Filed: May 5, 2005

(51) Int. Cl. A01N 59/04; A01N 25/12

(52) U.S. Cl. 504/101; 504/367

(57) ABSTRACT

Compositions used to apply a pesticide in solution form to absorbent, particulate substrates, including fertilizers are disclosed. The pesticide is dissolved in a methyl or ethyl ester and applied to the absorbent, particulate material surface. The pesticide solution absorbs into the absorbent, particulate substrate yielding less associated dust than an absorbent, particulate substrate coated with the pesticide alone.

### BACKGROUND OF THE INVENTION

1. Field of the Invention

The present invention relates, generally, to a composition used to apply a pesticide in solution form to absorbent, particulate substrates, including fertilizers. The pesticide is dissolved in a methyl or ethyl ester and applied to the particulate substrate surface. The pesticide solution absorbs into the fertilizer, resulting in reduced dust levels.

2. Description of the Related Art

Blended fertilizers are manufactured primarily using raw materials that contain nitrogen, phosphorous, and potassium or combinations of these elements (collectively referred to herein as “NPK”). The final proportions of these essential elements will be defined either by the crop or growing season that the fertilizer is intended for or by deficiencies in the growing medium.

An increasingly common practice is to add minor components to the blended NPK material to improve the effectiveness of the fertilizer, to enhance handling characteristics, or to impart additional beneficial agronomic properties. In this way, micronutrients such as zinc and sulfur are incorporated, anti-caking additives are added, and herbicides and pesticides are included to control unwanted weeds, insects and nematodes.

Although “pesticides” is used throughout the specification, it is defined to mean herbicides, insecticides, and other material used to control unwanted or nuisance items such as weeds, insects, etc., on grounds. Many of these pesticides are high melting point organic solids that if added as a powder are difficult to distribute and result in a dusty product with consequential health issues by those handling the fertilizer. The most common method of incorporating these addtitives is therefore to melt the material and spray in onto the fertilizer in a blender. Product quality issues and safety and health issues associated with applying the pesticides as a melted liquid include:
(a) The high temperature required may present a health hazard to the blender operators, because of excessive fume generation.
(b) The coating is brittle and on handling can break off and separate from the granules causing uneven distribution of the herbicide or pesticide throughout the fertilizer.
(c) The herbicide and/or pesticide that is no longer coated on the granules can break down further on handling to cause hazardous dust.

We have discovered that many of the pesticides used in the NPK fertilizer industry have a relatively high solubility in methyl or ethyl esters of fatty acids; moreover, this makes it possible to produce a solution of the pesticide. Two of the advantages offered through application of the pesticide in solution form are:
(a) The solution can be sprayed at a much lower temperature, which considerably reduces any fuming hazards.
(b) The pesticide solution is substantially absorbed into the granule and the active material becomes part of the granule, maintaining homogeneity of the blend, and reducing any tendency to cause dust on further handling.

Herbicides that have been incorporated into fertilizer blends in this manner include Pendimethalin™ and Ronstar™ herbicides. Insecticides include Carbaryl™ and Bifenthrin™ insecticides.

### SUMMARY OF THE INVENTION

In accordance with the present invention, a composition for coating fertilizers or any suitable absorptive, particulate material with a pesticide solution is provided. Fertilizers of the present invention include a nitrogen nutrient source in combination with one or more of a phosphorous nutrient source, a potassium nutrient source, a secondary nutrient source and a micronutrient source. Fertilizers of the present invention include organic materials, inorganic materials and combinations thereof which are granulated, crushed, pelletized, compacted, crystalline or prilled solids and combinations thereof. The coating contains the pesticide and an effective amount of a methyl or ethyl ester diluent. The ester diluent is a methyl or ethyl ester of fatty acids and is derived from animal, plant and/or synthetic materials. The effective amount of the ester diluent is from about 50% to about 99.9% by weight of the total pesticide compostion. The viscosity of the pesticide composition is from about 3 cP to 20000 cp at 60° C. Fertilizers coated with these inventive pesticide compositions have less associated dust than do fertilizers coated with the pesticide in melt form.

The invention accordingly comprises the features and combination of elements in the following description and its scope will be pointed out in the appended claims. de

### DETAILED DESCRIPTION OF THE INVENTION

The present invention relates to a composition used to apply a pesticide in solution form to fertilizers. The pesticide may be in solid form, usually as a powder. The pesticide is dissolved at a level of at least 50% by weight in the methyl or ethyl ester, usually at an elevated temperature and with stirring. The pesticide solution may be sprayed into a coating drum to coat the fertilizer surface. The pesticide solution absorbs into the fertilizer and becomes a part of the fertilizer, as opposed to only partially adhering to the surface of the fertilizer, as would be expected to occur in the case of coating with a pesticide melt.

The methyl and/or ethyl esters useful in the present invention can be separated following reaction of methanol or ethanol, by methods known in the art, with various fats or vegetable oils including, but not limited to, tall oil, rapeseed oil, sunflower oil, corn oil, safflower oil and soybean oil. Methyl or ethyl esters may also be produced following reaction of methanol or ethanol, by methods known in the art, with various free fatty acids derived from animal, vegetable or synthetic sources including, but not limited to, tall oil, rapeseed oil, sunflower oil, corn oil, safflower oil and soybean oil. The esters useful in the present invention (see general formula below) are derived from fatty acids with n ranging from 5 to 23. The fatty acid-derived portion of the ester may also contain from 1 to 3 double bonds, depending on the oil or fat source, with the following general formula 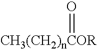
wherein R may be CH₃CH₂— or CH₃— with methyl esters being the preferred diluents.

The pesticide compositions are used to coat organic and inorganic fertilizer compositions, as well as combinations thereof. The fertilizer or bulk solid, useful in the present invention, is in a granular, pelletized, crushed, compacted, crystalline or prilled form. The pesticide compositions of the present invention do not interfere with the quality grade or rate of release of fertilizers or other absorbent, particulate substrates. In particular, the pesticide compositions of the present invention contain an effective amount of a methyl and/or ethyl ester, which is sufficient to dilute the pesticide to provide a coating material having a viscosity that is suitable for spraying an even distribution on the fertilizers to reduce dust formation while maintaining the quality and nutrient release rate of the fertilizer. The coating composition of the present invention changes the surface characteristics of the fertilizer, rendering it resistant to caking and dust formation during shipment and storage.

### EXAMPLES

The following examples serve to provide further appreciation of the invention and are not meant in any way to restrict the effective scope of the invention.

### Example 1

### Determination of Dust Levels

Coating materials were prepared in the following manner.

A pesticide solution to be used in coating a fertilizer was prepared by mixing Ronstar™ herbicide with a fatty acid methyl ester in a 250 mL Erlenmeyer flask at percentages by mass listed in Table 1 below. The resultant Ronstar/methyl ester mixture was heated to 140° F. and stirred until a clear solution was obtained. The Ronstar/methyl ester solution was kept at 140° F. before coating to maintain the Ronstar in solution.

A second coating was prepared by heating solid Ronstar herbicide to approximately 200° F. in a 250 mL Erlenmeyer flask. The Ronstar melt was kept at 200° F. before coating to maintain flowability.

Fertilizer samples were coated in the following manner.

Samples of 6-6-6 fertilizer (200 g) were added to wide-mouth, glass quart jars and placed in a 140° F. oven. After 1 hour, fertilizer samples were removed from the oven and were coated with the Ronstar/methyl ester solution at percentages listed in Table 1. Remaining samples were coated with the Ronstar melt at percentages listed in Table 1.

Specifically, the particular coating was added to each respective container of fertilizer in a dropwise fashion, followed by rolling each container on a rock tumbler for five minutes. A heat gun was directed at each container of fertilizer during the five-minute tumbling process.

Dust levels of each sample were measured using a dust tower such as that disclosed in U.S. Pat. No. 6,062,094. Dust levels were measured at 0 (initial), 1, 2, 3 and 4 weeks. The results of these dust level determinations are shown in Table 1 below.

TABLE 1
Initial and Cumulative Dust Levels for 6-6-6 Fertilizer Treated with
Ronstar/Methyl Ester Solutions versus Ronstar Melt

| | (% by | Effective % | Week | | | | |
|---|---|---|---|---|---|---|---|
| | weight | Ronstar on | 0 | 1 | 2 | 3 | 4 |
| Coating | on fertilizer) | fertilizer | Ave. Cumulative Dust (lb/ton) | | | | |
| 100% | 0.5 | 0.5 | 8.63 | 16.79 | 25.74 | 31.37 | 36.99 |
| Ronstar | | | | | | | |
| 50% | 1.0 | 0.5 | 5.92 | 12.37 | 17.47 | 25.97 | 29.47 |
| Ronstar | | | | | | | |
| solution | | | | | | | |
| 25% | 2.0 | 0.5 | 2.18 | 4.72 | 7.06 | 12.69 | 18.41 |
| Ronstar | | | | | | | |
| solution | | | | | | | |
| 10% | 5.0 | 0.5 | 0.54 | 1.61 | 3.57 | 6.94 | 10.47 |
| Ronstar | | | | | | | |
| solution | | | | | | | |
| 100% | 2.0 | 2.0 | 11.3 | 18.83 | 26.34 | 31.63 | 36.10 |
| Ronstar | | | | | | | |
| 50% | 4.0 | 2.0 | 2.89 | 9.41 | 16.41 | 22.18 | 26.65 |
| Ronstar | | | | | | | |
| solution | | | | | | | |

As shown in TABLE 1, at equivalent masses of Ronstar application, the fertilizer coated with the Ronstar/methyl ester solution produced less dust when compared to the fertilizer coated with the Ronstar melt. For example, the 50% Ronstar solution applied at 1.0% by weight of fertilizer represents a 0.5% effective application rate of solid Ronstar. Less dust is yielded at every test interval for fertilizer treated at 1.0% by weight with 50% Ronstar/methyl ester coating versus fertilizer treated at 0.5% by weight of the Ronstar melt.

Thus, while there has been described what are presently believed to be the preferred embodiments of the invention, those skilled in the art will understand that other and further modifications can be made without departing from the spirit of the invention. It is intended that the present invention include all such modifications as come within the scope of the invention as set forth in the claims.

What is claimed is:

1. A composition for coating an absorbent, particulate substrate with a solution of a pesticide composition, the coating composition comprising:
a pesticide and an effective amount of a diluent selected from the group of methyl or ethyl esters of fatty acids and combinations thereof suitable to substantially dissolve the pesticide wherein the formed coating composition has a viscosity suitable for spraying a generally even distribution on the absorbent, particulate substrate, and
wherein an absorbent, particular substrate coated with said coating composition has less fugitive dust than another similar absorbent, particulate substrate coated with a composition consisting of the pesticide alone.

2. The composition according to claim 1, wherein the absorbent, particulate substrate is a blended or granulated fertilizer comprising a nitrogen nutrient source in combination with one or more of
a phosphorous nutrient source,
a potassium nutrient source, and
a secondary nutrient source consisting of calcium, sulfur and/or magnesium and a micronutrient source and mixtures thereof.

3. The composition according to claim 1, wherein the absorbent, particulate substrate is of a form selected from the group of granular, crushed, compacted, crystalline and prilled fertilizer and combinations thereof.

4. The composition according to claim 1, wherein the absorbent, particulate substrate is a form of vermiculite, perlite, attapulgite clay, cellulose or any other suitable absorbent material and combinations thereof.

5. The composition according to claim 1, wherein the methyl or ethyl esters of fatty acids and combinations thereof are derived from animal, plant and synthetic materials.

6. The composition according to claim 1, wherein the effective amount of diluent is from about 50% to about 90% by weight of the total weight of the coating composition.

7. A method for reducing the dust levels of an absorbent, particulate substrate comprising: coating an absorbent, particulate substrate with a solution of a pesticide comprising the pesticide and an effective amount of diluent selected from the group of methyl or ethyl esters of fatty acids and combinations thereof suitable to dilute the pesticide, wherein the formed coating composition has a viscosity suitable for spraying a generally even distribution on the absorbent, particulate substrate, and
wherein the absorbent, particular substrate coated with said coating composition has less fugitive dust than another similar absorbent, particulate substrate coated with a composition consisting of the pesticide alone.

8. The method according to claim 7, wherein the absorbent, particulate substrate is of a form selected from the group of granular, crushed, compacted, crystalline and prilled fertilizers and combinations thereof.

9. The method according to claim 7, wherein the methyl or ethyl esters and combinations thereof are derived from animal, plant and synthetic materials.

10. The method according to claim 7, wherein the absorbent, particulate substrate is an organic material, an inorganic material and combinations thereof.

11. The method according to claim 7, wherein the effective amount of diluent is from about 50% to about 90% by weight of the total weight of the coating composition.
